(19) United States
(12) Patent Application Publication
(10) Pub. No.: US 2026/0087636 A1
(43) Pub. Date: Mar. 26, 2026

(54) GENERATING SEGMENTATIONS OF SEMANTICALLY RELEVANT OBJECTS FROM VECTOR IMAGES USING VECTOR HIERARCHY SEARCHING

(71) Applicant: Adobe Inc., San Jose, CA (US)

(72) Inventors: Abhishek Rai, Noida (IN); Amit Vikram Singh, Varanasi (IN); Nitesh Dodeja, Delhi (IN); Vineet Batra, Pitam Pura (IN)

(21) Appl. No.: 18/897,254

(22) Filed: Sep. 26, 2024

(51) Int. Cl. G06T 7/12; G06T 5/20; G06V 10/764

(52) U.S. Cl. CPC G06T 7/12; G06T 5/20; G06V 10/764; G06T 2207/20084

(57) ABSTRACT

Methods, systems, and non-transitory computer readable storage media are disclosed for determining semantically relevant sets of objects in vector images. The disclosed system generates one or more group masks corresponding to user-tagged groups of objects in a vector image by executing a search on a vector hierarchy of the vector image. The disclosed system determines, from the one or more group masks, a group mask comprising a semantically relevant set of objects based on semantic information from one or more segmentation masks comprising a plurality of semantic segmentations generated utilizing one or more segmentation neural networks. Additionally, the disclosed system extracts, from the group mask, one or more masks corresponding to the semantically relevant set of objects.

### BACKGROUND

Many tasks involving digital media utilize vector images due to the lossless, scalable nature of vector images. For example, many entities utilize vector images in a wide range of digital content due to the flexibility and accuracy in portraying objects when rendering for display on a display device or in physical media printed from digital media. Additionally, the precise, visually clean nature of vector images makes them ideal for certain types of visual content, styles, and downstream image processing applications. Utilizing vector images for downstream operations that rely on additional information associated with the vector images (e.g., semantic information) is often difficult due to the inconsistency of storage structures of vector images and the lack of high quality vector images. Specifically, accurately training image processing neural networks is a challenging task that typically requires high volumes of image data with specific labeling requirements (e.g., according to semantic information). Conventional systems lack the ability to accurately and efficiently process vector images (or vector-like images) for such downstream operations.

### SUMMARY

One or more embodiments provide benefits and/or solve one or more of the foregoing or other problems in the art with systems, methods, and non-transitory computer readable storage media for grouping semantically relevant objects in vector images via machine-learning segmentation and vector hierarchy searching. In particular, the disclosed systems utilize one or more segmentation neural networks to generate segmentation masks for a vector image. Additionally, the disclosed systems search (e.g., via breadth first searching) a vector hierarchy of the vector image to identify user-tagged groups of objects and generate group masks for the user-tagged groups. The disclosed systems compare the segmentation masks to the group masks (e.g., via bipartite matching) to determine semantically relevant sets of objects based on the semantic information in the segmentation masks. Furthermore, in some embodiments, the disclosed systems extract one or more masks (e.g., full or partial masks) and/or other information corresponding to the semantically relevant sets of objects for various downstream image processing tasks. The disclosed systems thus provide fast and accurate detection and grouping of semantically relevant vector objects in vector images.

### BRIEF DESCRIPTION OF THE DRAWINGS

Various embodiments will be described and explained with additional specificity and detail through the use of the accompanying drawings.

FIG. 1 illustrates an example system environment in which a vector object grouping system operates in accordance with one or more implementations.

FIG. 2 illustrates a diagram of an overview of the vector object grouping system determining semantically relevant sets of objects in a vector image in accordance with one or more implementations.

FIG. 3 illustrates a diagram of a plurality of segmentation neural networks generating segmentation masks for a vector image in accordance with one or more implementations.

FIG. 4 illustrates a diagram of the vector object grouping system determining user-tagged groups of objects in a vector image via a vector hierarchy search in accordance with one or more implementations.

FIG. 5 illustrates a diagram of the vector object grouping system generating group masks for semantically relevant sets of objects in a vector image in accordance with one or more implementations.

FIG. 6 illustrates a diagram of the vector object grouping system generating training data from a group mask of a semantically relevant set of objects in accordance with one or more implementations.

FIG. 7 illustrates a diagram of the vector object grouping system training an image processing neural network utilizing data generated from semantically relevant sets of objects in accordance with one or more implementations.

FIG. 8A illustrates an example graphical user interface of a vector image and semantically relevant sets of objects highlighted in the vector image in accordance with one or more implementations.

FIG. 8B illustrates an example graphical user interface of a plurality of masks and color images generated for semantically relevant sets of objects of a vector image in accordance with one or more implementations.

FIG. 9 illustrates a diagram of the vector object grouping system filtering vector images from a dataset based on image content in the vector images in accordance with one or more implementations.

FIG. 10 illustrates a diagram of an example of the vector object grouping system in accordance with one or more implementations.

FIG. 11 illustrates a flowchart of a series of acts for determining semantically relevant sets of objects in a vector image based on semantic segmentations and user-tagged groups in accordance with one or more implementations.

FIG. 12 illustrates a block diagram of an exemplary computing device in accordance with one or more implementations.

### DETAILED DESCRIPTION

One or more embodiments of the present disclosure include a vector object grouping system that segments semantically relevant groups of objects in vector images. Specifically, the vector object grouping system determines segmentation masks including semantic information for objects in a vector image based on semantic segmentations generated by one or more segmentation neural networks. Additionally, the vector object grouping system searches a vector hierarchy corresponding to a vector image to determine group masks for user-tagged groups of objects. By comparing the segmentation masks and the group masks, the vector object grouping system utilizes the semantic information from the segmentation masks to identify group masks that contain semantically relevant sets of objects (i.e., a group mask that includes objects that are semantically related). Furthermore, the vector object grouping system utilizes the group masks of semantical relevant sets of objects to perform additional downstream tasks, such as generating masks or other data.

As mentioned, in one or more embodiments, the vector object grouping system determines segmentation masks including semantic information for objects in a vector image. For example, the vector object grouping system utilizes one or more segmentation neural networks to generate one or more sets of semantic segmentations for the vector image. Additionally, the vector object grouping system generates segmentation masks including the semantic segmentations for one or more objects (or parts of objects) in the vector image.

In one or more embodiments, the vector object grouping system searches a vector hierarchy for a vector image to determine user-tagged groups of objects. To illustrate, the vector object grouping system utilizes a search algorithm (e.g., a breadth first search algorithm) to search nodes in the vector hierarchy of a vector file to identify nodes (e.g., groups of objects) indicated as a user-tagged group. For instance, some vector files (e.g., SVGs) include nodes corresponding to objects with metadata that indicates that a plurality of objects in a vector image are grouped together. Additionally, the vector object grouping system generates group masks corresponding to the user-tagged groups of objects.

Furthermore, according to one or more embodiments, the vector object grouping system utilizes the semantic information in the segmentation masks to select group masks that include semantically relevant sets of objects. In particular, the vector object grouping system compares the group masks to the segmentation masks to determine semantically relevant groups of objects, such as by determining how closely the group masks overlap with the segmentation masks. In one or more embodiments, the vector object grouping system utilizes bipartite matching to generate intersection-over-union metrics for each segmentation mask/group mask pair. Based on the similarity/overlap, the vector object grouping system selects one or more group masks that include semantically relevant groups of objects.

In additional embodiments, the vector object grouping system generates data based on semantically relevant sets of objects. Specifically, the vector object grouping system generates one or more masks (e.g., partial or full masks) and/or other data (e.g., color images) corresponding to the semantically relevant sets of objects. Additionally, in some embodiments, the vector object grouping system utilizes the generated data for one or more downstream operations, such as training an image processing neural network, layered vectorization, or inpainting tasks.

Conventional systems that provide image processing for digital images often utilize machine-learning segmentation to identify and extract semantic information from the digital images. Specifically, segmentation neural networks attempt to break a digital image into separate parts with semantic information that indicates individually detected objects based on specific semantic concepts. Although such conventional systems are able to segment digital images by various semantic concepts, these conventional systems often inaccurately segment objects into groups of semantically related parts. To illustrate, many conventional systems that utilize segmentation neural networks are able to individually identify body parts or components of an object, the conventional systems often incorrectly group related objects together (e.g., separate parts of a greater whole).

Furthermore, some conventional systems attempt to extend training datasets for training certain image processing neural networks by transforming existing datasets of digital images into vector-like representations. For example, such conventional systems utilize various image processing tasks to convert datasets of realistic images into vector-like images. These conventional systems, however, generate modified images that do not resemble typical vector images. Indeed, such conventional systems often generate vector images with visual artifacts in certain portions while removing necessary details (e.g., edge details) in other portions.

Additionally, some conventional systems provide tools for assigning various vector objects to groups. While these conventional systems provide tools for grouping various objects with different levels of granularity, most vector images modified with such tools are unusable for certain image processing tasks. Specifically, most groups created by users are to make editing the vector images easier (e.g., by grouping vector objects close in proximity) without taking into account semantic relativity. In some cases, these conventional systems result in multiple semantic objects being grouped together in a single group while tagging only sub-portions of other semantic objects. Thus, such vector images are not usable in training datasets for training image processing neural networks to accurately identify semantic objects in vector images.

The vector object grouping system provides a number of improvements in computing systems that edit vector images and generate training data for image processing tasks involving vector images. For example, the vector object grouping system leverages semantic information from machine-learning segmentations of vector images to select tagged groups of semantically relevant sets of objects. In contrast to conventional systems that rely entirely on segmentation neural networks to generate masks for digital images, the vector object grouping system utilizes the semantic information included in machine-learning segmentations to filter grouped objects. Thus, the vector object grouping system provides accurate detection of grouped objects that include objects that are semantically relevant to each other in vector images.

Additionally, the vector object grouping system improves the accuracy and flexibility of computing systems that use vector images for various downstream tasks. In contrast to conventional systems that rely on inaccurate segmentations or non-semantic grouping of objects in vector images, the vector object grouping system groups objects based on their semantic relationships with each other. By grouping vector objects semantically, the vector object grouping system provides more accurate information for downstream tasks such as training image processing neural networks, vector image segmentation, layered vectorization, layer-wise object completion, object extraction from composite files, or inpainting partial objects in vector images.

For example, determining semantically related objects in vector images allows the vector object grouping system to generate or augment image datasets with greater granularity of segmentations. In particular, the vector object grouping system provides mask generation for individual portions of objects as well as for combinations of portions as part of larger objects in vector images. To illustrate, by generating partial or full masks from semantically relevant sets of objects in vector images, the vector object grouping system provides improved training data generation for training image processing neural networks to better process and generate vector images (e.g., in text-to-vector image generation/editing tasks).

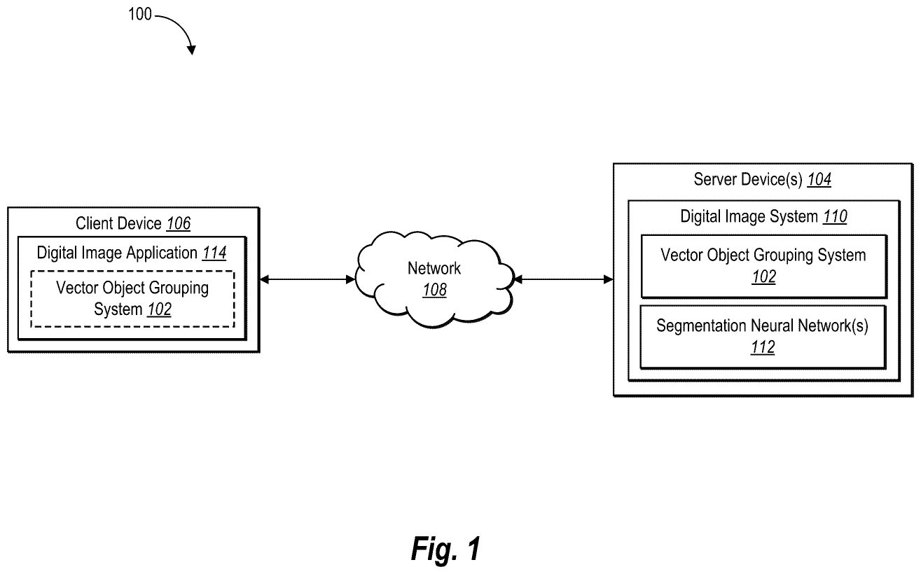

Turning now to the figures, FIG. 1 includes an embodiment of a system environment 100 in which a vector object grouping system 102 is implemented. In particular, the system environment 100 includes server device(s) 104 and a client device 106 in communication via a network 108. Moreover, as shown, the server device(s) 104 include a digital image system 110, which includes the vector object grouping system 102. Furthermore, in some embodiments, the digital image system 110 also includes segmentation neural network(s) 112. Additionally, the client device 106 includes a digital image application 114, which optionally includes the vector object grouping system 102 (or the digital image system 110).

As shown in FIG. 1, the client device 106 or the server device(s) 104 include or host the digital image system 110. The digital image system 110 includes, or is part of, one or more systems that implement digital image generation or editing operations. For example, the digital image system 110 provides tools for generating or editing digital images (e.g., vector images). To illustrate, the digital image system 110 communicates with the client device 106 via the network 108 to provide the tools for display and interaction via the digital image application 114 at the client device 106. Additionally, in some embodiments, the digital image system 110 receives requests to access digital image data stored (e.g., at the server device(s) 104 or at another device such as a database) and/or requests to store digital image data. In some embodiments, the digital image system 110 receives interaction data for viewing or performing various image processing operations and provides the results of the interaction data (e.g., generated digital image data) for display via the digital image application 114 or to a third-party system. In additional embodiments, the digital image system 110 provides tools for generating data (e.g., training data) for various downstream operations (e.g., training image processing neural networks).

According to one or more embodiments, the digital image system 110 utilizes the vector object grouping system 102 to generate, edit, or otherwise process vector images. In particular, the vector object grouping system 102 detects semantically related objects in vector images and groups the semantically related objects. For example, the vector object grouping system 102 utilizes the segmentation neural network(s) 112 to generate segmentation masks for a vector image. The vector object grouping system 102 utilizes semantic information from the segmentation masks to detect semantically relevant sets of objects in the vector image. In some embodiments, the vector object grouping system 102 utilizes the groups of semantically related objects for various image editing or analysis tasks. For example, the vector object grouping system 102 utilizes groups of semantically relevant sets of objects to generate masks and/or image data for training image processing neural networks. In additional embodiments, the vector object grouping system 102 utilizes groups of semantically relevant sets of objects to generate layers for vector images.

As illustrated in FIG. 1, the vector object grouping system 102 is implemented on the client device 106 or on the server device(s) 104. In particular, in some implementations, the vector object grouping system 102 on the server device(s) 104 supports the vector object grouping system 102 on the client device 106. For instance, the server device(s) 104 generates or obtains the vector object grouping system 102 for the client device 106 (e.g., as part of a software application or suite). The server device(s) 104 provides the vector object grouping system 102 to the client device 106 for performing digital image editing processes at the client device 106. In other words, the client device 106 obtains (e.g., downloads) the vector object grouping system 102 from the server device(s) 104. At this point, the client device 106 is able to utilize the vector object grouping system 102 to edit digital images independently from the server device(s) 104.

In additional embodiments, although FIG. 1 illustrates the server device(s) 104 and the client device 106 communicating via the network 108, the various components of the system environment 100 communicate and/or interact via other methods (e.g., the server device(s) 104 and the client device 106 communicate directly). Furthermore, although FIG. 1 illustrates the vector object grouping system 102 being implemented by a particular component and/or device within the system environment 100, the vector object grouping system 102 is implemented, in whole or in part, by other computing devices and/or components in the system environment 100. For example, in some embodiments, the server device(s) 104 include or host the digital image system 110 and/or the vector object grouping system 102.

To illustrate, the vector object grouping system 102 includes a web hosting application that allows the client device 106 to interact with content and services hosted on the server device(s) 104 (e.g., in a software as a service implementation). To illustrate, in one or more implementations, the client device 106 accesses a web page supported by the server device(s) 104. The client device 106 provides input to the server device(s) 104 to view information for image editing tasks and, in response, the vector object grouping system 102 or the digital image system 110 on the server device(s) 104 performs operations to edit or process vector images. The server device(s) 104 provide the output or results of the operations to the client device 106.

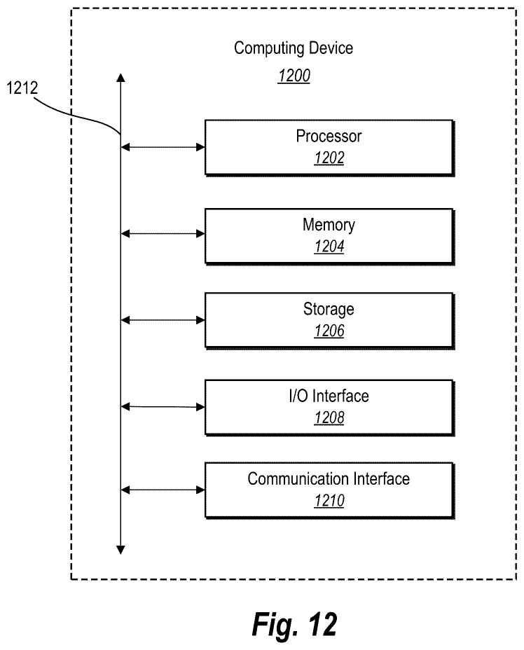

In one or more embodiments, the server device(s) 104 include a variety of computing devices, including those described below with reference to FIG. 12. For example, the server device(s) 104 include one or more servers for storing and processing data associated with image editing processes. In some embodiments, the server device(s) 104 also include a plurality of computing devices in communication with each other, such as in a distributed storage environment. In some embodiments, the server device(s) 104 include a content server. The server device(s) 104 also optionally include an application server, a communication server, a web-hosting server, a social networking server, a digital content campaign server, or a digital communication management server.

In addition, as shown in FIG. 1, the system environment 100 includes the client device 106. In one or more embodiments, the client device 106 includes, but is not limited to, a mobile device (e.g., smartphone or tablet), a laptop, a desktop, including those explained below with reference to FIG. 12). Furthermore, although not shown in FIG. 1, the client device 106 is operable by a user (e.g., a user included in, or associated with, the system environment 100) to perform a variety of functions. In particular, the client device 106 performs functions such as, but not limited to, accessing, viewing, generating, and editing digital images. In some embodiments, the client device 106 also performs functions for generating, capturing, or accessing data to provide to the digital image system 110 and the vector object grouping system 102 in connection with editing digital images. For example, the client device 106 communicates with the server device(s) 104 via the network 108 to provide information (e.g., user interactions) associated with digital images. Although FIG. 1 illustrates the system environment 100 with a single client device, in some embodiments, the system environment 100 includes a different number of client devices.

Additionally, as shown in FIG. 1, the system environment 100 includes the network 108. The network 108 enables communication between components of the system environment 100. In one or more embodiments, the network 108 may include the Internet or World Wide Web. Additionally, the network 108 optionally include various types of networks that use various communication technology and protocols, such as a corporate intranet, a virtual private network (VPN), a local area network (LAN), a wireless local network (WLAN), a cellular network, a wide area network (WAN), a metropolitan area network (MAN), or a combination of two or more such networks. Indeed, the server device(s) 104 and the client device 106 communicates via the network using one or more communication platforms and technologies suitable for transporting data and/or communication signals, including any known communication technologies, devices, media, and protocols supportive of data communications, examples of which are described with reference to FIG. 12.

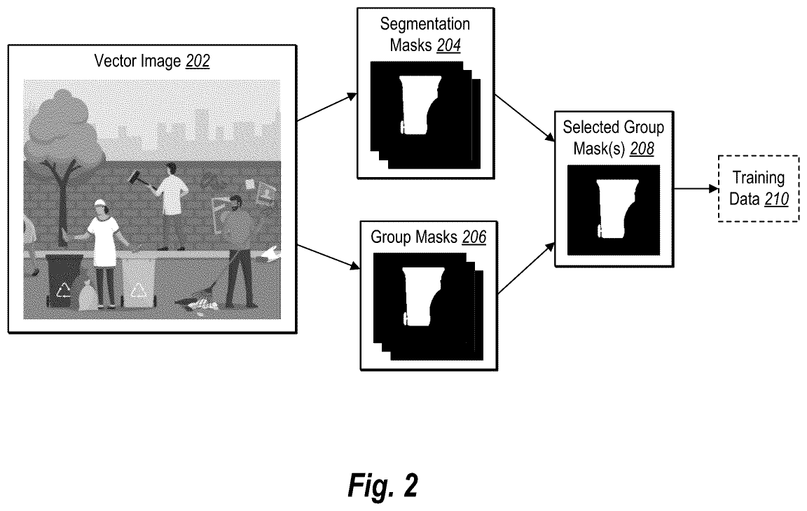

As mentioned, the vector object grouping system 102 utilizes machine-learning generated segmentations with tagged groups of objects in vector images to detect semantically relevant sets of objects. FIG. 2 illustrates an overview diagram of the vector object grouping system 102 utilizing semantic information with user tagging information to group semantically relevant sets of objects in a vector image. FIG. 2 also illustrates that the vector object grouping system 102 optionally utilizes information about groups of semantically relevant sets of objects for additional downstream operations such as training an image processing neural network.

In one or more embodiments, the vector object grouping system 102 determines a vector image 202 including various vector objects. For example, the vector image 202 includes one or more objects arranged in a scene with a background of one or more vector objects and a foreground of one or more vector objects. Furthermore, in some embodiments, the vector image 202 includes vector objects that make up portions of semantic objects (e.g., individual parts of a whole object). To illustrate, the vector image 202 includes people and various objects arranged in a street scene in which each object is made up of other, smaller objects.

In one or more embodiments, a semantic object includes any object corresponding to a semantic concept that includes one or more parts. As an example, a person in the scene includes arms, legs, hair, articles of clothing, etc. Thus, a person is a semantic object made up of many other parts. In additional embodiments, individual parts of a greater object include semantic objects, such as separate parts of a person (e.g., hands, fingers, arms, head, eyes, mouths).

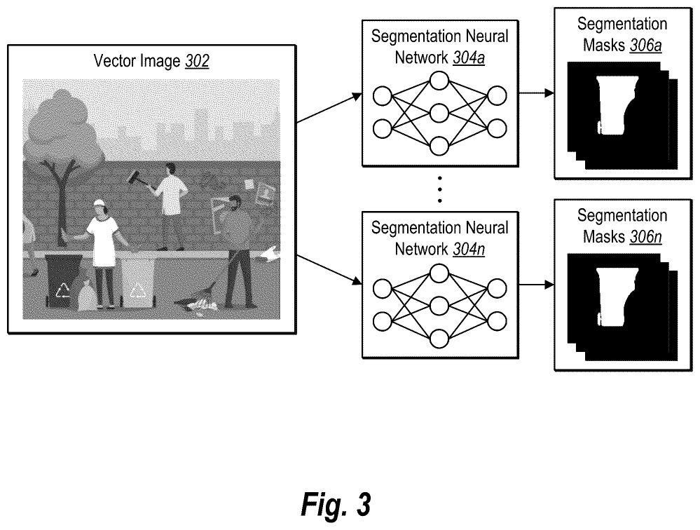

According to one or more embodiments, the vector object grouping system 102 determines segmentation masks 204 corresponding to individually identified objects in the vector image 202. For instance, the vector object grouping system 102 generates or obtains the segmentations masks based on segmentations generated utilizing one or more segmentation neural networks. As an example, the segmentation masks 204 include image masks (e.g., including values indicating the object and different values indicating areas outside the object) for various objects in the vector image 202 including individual parts of semantic objects and/or whole semantic objects (e.g., arms and/or a body). FIG. 3 and the corresponding description provide additional details related to generating segmentation masks for objects in vector images.

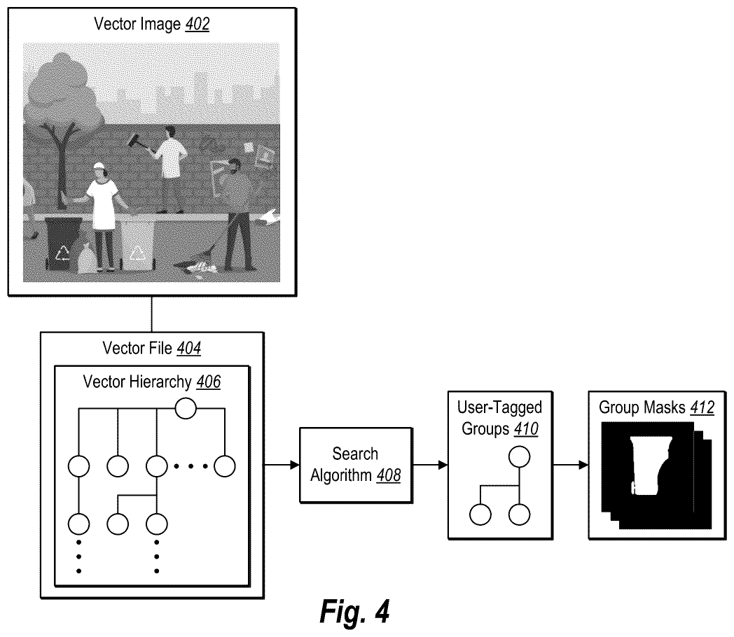

In one or more embodiments, the vector object grouping system 102 determines group masks 206 corresponding to sets of objects indicated as being part of groups in a vector image. In particular, the vector object grouping system 102 determines or generates the group masks 206 including image masks corresponding to portions of a vector indicated as being part of specific groups (e.g., via user-tagged groups). FIG. 4 and the corresponding description provide additional detail related to generating group masks for sets of objects in a vector image.

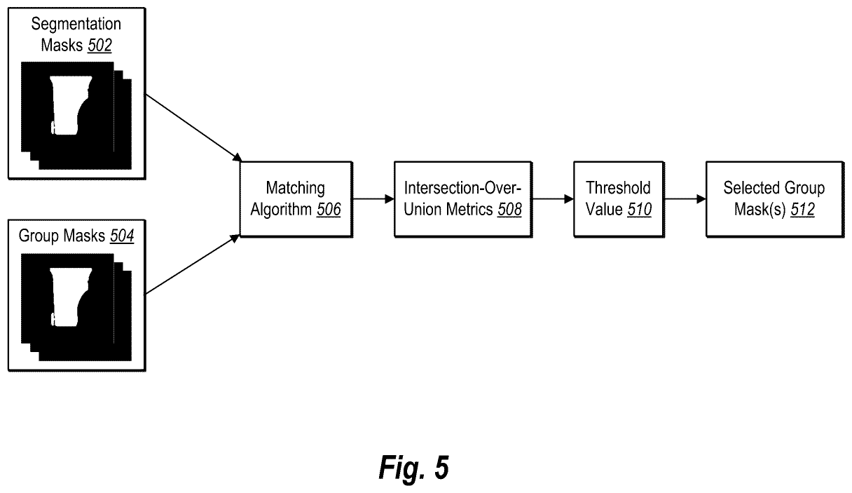

In at least some embodiments, the vector object grouping system 102 determines selected group mask(s) 208 for semantically relevant sets of objects in the vector image 202. Specifically, the vector object grouping system 102 utilizes the semantic information from the segmentation masks 204 to select one or more of the group masks 206 based on whether the corresponding objects are semantically relevant (e.g., semantically related to each other in connection with possible semantic objects). FIG. 5 and the corresponding description provide additional detail related to selecting group masks that include semantically relevant sets of objects.

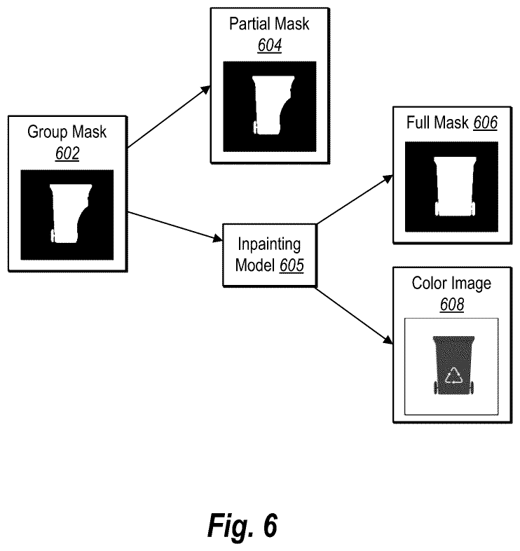

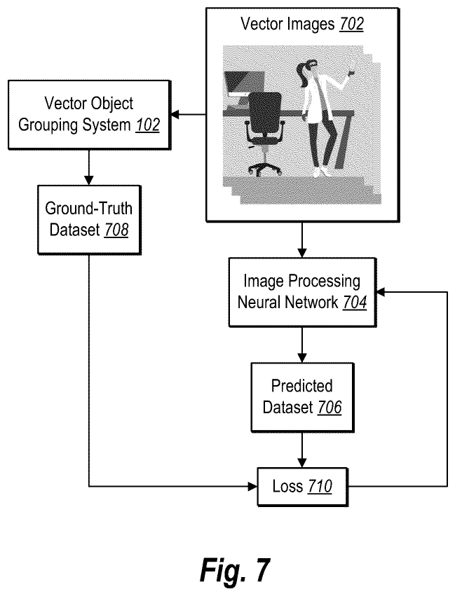

As mentioned, the vector object grouping system 102 optionally utilizes the selected group mask(s) 208 to perform additional downstream operations. As illustrated in FIG. 2, for example, the vector object grouping system 102 utilizes the selected group mask(s) 208 to generate training data 210 for training an image processing neural network. In additional embodiments, the vector object grouping system 102 generates vector image layer data for generating or editing layers of the vector image 202. In further embodiments, the vector object grouping system 102 utilizes the selected group mask(s) 208 to perform one or more inpainting tasks for the semantically relevant sets of objects. FIGS. 6-7 and the corresponding description provide additional detail related to generating training data and training an image processing neural network.

As mentioned, in one or more embodiments, the vector object grouping system 102 determines semantic information for segmentations of a vector image. FIG. 3 illustrates utilizing a plurality of segmentation neural networks to generate a plurality of sets of segmentation masks for a vector image.

As illustrated in FIG. 3, the vector object grouping system 102 determines a vector image 302 including a plurality of vector objects. In some embodiments, the vector object grouping system 102 also determines a plurality of segmentation neural networks 304a-304n to use for generating a plurality of sets of segmentation masks (e.g., segmentation masks 306a-306n). For example, the vector object grouping system 102 utilizes a plurality of different segmentation neural networks to generate different sets of segmentation masks for broader coverage of possible segmentations of objects in the vector image 302. More specifically, some types of segmentation neural networks are more accurate at generating segmentations for different types of objects or scenes than others. Thus, by utilizing the different segmentation neural networks to generate different sets of segmentation masks, the vector object grouping system 102 has a higher probability of finding all possible semantic objects in the vector image 302. In alternative embodiments, the vector object grouping system 102 utilizes a single segmentation neural network to generate a single set of segmentations.

In one or more embodiments, a neural network includes a machine learning model that is trainable and/or tunable based on inputs to determine classifications and/or scores, or to approximate unknown functions. For example, in some cases, a neural network includes a model of interconnected artificial neurons (e.g., organized in layers) that communicate and learn to approximate complex functions and generate outputs based on inputs provided to the neural network. In some cases, a neural network refers to an algorithm (or set of algorithms) that implements deep learning techniques to model high-level abstractions in data. A neural network includes various layers such as an input layer, one or more hidden layers, and an output layer that each perform tasks for processing data. For example, a neural network includes a deep neural network, a convolutional neural network, a diffusion neural network, a recurrent neural network (e.g., an LSTM), a graph neural network, a transformer, or a generative adversarial neural network. Furthermore, in one or more embodiments, a segmentation neural network includes one or more encoder layers and one or more decoder layers to generate segmentations and/or segmentation masks corresponding to detected objects in a digital image.

In one or more embodiments, as mentioned, the sets of segmentation masks 306a-306n include image masks with values indicting areas that are part of a detected area (e.g., a semantic object) and areas that are outside the detected area. For example, a segmentation mask includes an image with a first value indicating a detected object (e.g., 1) and a second value indicating a portion outside the detected object (e.g., 0). In additional embodiments, a segmentation mask includes an alpha matte with a range of values to indicate transparencies (e.g., for objects with soft boundaries such as hair or fur).

In one or more embodiments, the vector object grouping system 102 converts the vector image 302 to a raster image for processing by the segmentation neural networks 304a-304n. For example, the vector object grouping system 102 rasterizes the vector image 302 to convert the paths in the vector image into a pixel-based image with RGB values (or other color values) representing the image content. The vector object grouping system 102 thus generates the segmentation masks 306a-306n utilizing the segmentation neural networks 304a-304n on the raster image representing the vector image 302.

According to one or more embodiments, the vector object grouping system 102 determines sets of objects that are tagged as groups in a vector image. For example, some digital image applications provide tools for tagging two or more vector objects together as a group (e.g., by grouping the vector objects into a selectable group). FIG. 4 illustrates an example of the vector object grouping system 102 utilizing tagged groups of vector objects in a vector image to generate group masks for the tagged groups.

In one or more embodiments, the vector object grouping system 102 determines a vector image 402 and a vector file 404 corresponding to the vector image 402. In particular, the vector file 404 includes a data structure storing vector objects in the vector image 402. For example, the vector file 404 includes a vector file format (e.g., SVG) to store the vector objects. Furthermore, in one or more embodiments, the vector objects include lines and/or curves (e.g., splines such as Bezier curves) and path, style, or fill information associated with the lines/curves.

Additionally, as illustrated in FIG. 4, the vector file 404 includes a vector hierarchy 406. Specifically, the vector hierarchy 406 includes information about relationships between vector objects in the vector file 404. For instance, the vector hierarchy 406 includes information about individual vector objects and group objects. To illustrate, the vector hierarchy includes a tree structure with nodes representing objects in the vector file 404, with each node (or set of linked nodes) including information that the corresponding object is a single path object or a group of vector objects.

Accordingly, in one or more embodiments, the vector object grouping system 102 utilizes a search algorithm 408 to search the vector hierarchy 406 of the vector file 404 for tagged groups. For example, the vector object grouping system 102 utilizes a breadth first search algorithm to traverse the vector hierarchy 406 by searching all nodes at a specific depth in the vector hierarchy 406 before moving to the next depth. To illustrate, the vector object grouping system 102 visits each of the nodes at a first depth of a tree structure to determine whether each node at the first depth indicates that the node corresponds to a group of objects before moving to the second depth of the tree structure. In alternative embodiments, the vector object grouping system 102 utilizes a different search algorithm, such as a depth first search.

In one or more embodiments, in response to determining that a node in the vector hierarchy 406 is tagged as a group, the vector object grouping system 102 identifies all of the child nodes of the node and adds the vector object grouping system 102 to a list of user-tagged groups 410. In particular, the vector object grouping system 102 obtains the nodes linked to the selected node at greater depths (e.g., direct child nodes and nodes linked to the child nodes). Additionally, the vector object grouping system 102 appends additional path information for each of the nodes to the corresponding group in the list of user-tagged groups 410. In response to determining that a particular node is not tagged as a group, the vector object grouping system 102 moves to the next node at the same depth or at the next depth if no more nodes are left to search in the current depth.

As illustrated in FIG. 4, the vector object grouping system 102 determines a list of user-tagged groups 410 from the vector hierarchy 406 based on indications of sets of grouped objects in the vector file 404. In one or more embodiments, the vector object grouping system 102 generates group masks 412 for the groups in the list of user-tagged groups 410. For instance, the vector object grouping system 102 generates a group mask for a set of objects in a user-tagged group by combining the objects and generating a mask based on the combination of objects. Thus, the vector object grouping system 102 generates masks for sets of objects explicitly indicated as belonging to groups in the vector file 404.

In one or more embodiments, the vector object grouping system 102 utilizes a plurality of operations in Algorithm 1 below to generate group masks (i.e., “BFS Masks”) according to a breadth first search algorithm on vector hierarchies corresponding to vector images.

Algorithm 1 BFS Masks

Require: Vector Tree T_{avg}

| 1: | procedure GETCHILDPATHLIST(G_{avg}) | |
|---|---|---|
| 2: | childPathList ← ∅ | |
| 3: | for all child ∈ G_{avg} do | |
| 4: | if child is a path then | |
| 5: | childPathList ← childPathList ∪ child | |
| 6: | else if child is a group then | |
| 7: | childPathList ← childPathList ∪ GatChildPathList(child) | |
| 8: | end if | |
| 9: | end for | |
| 10: | end procedure | |
| 11: | | |
| 12: | procedure UPDATPATHCOLOR(Path_{avg}, color) | |
| 13: | Set Path_{avg} Fill with color | |
| 14: | Set Path_{avg} Storke with color | |
| 15: | end procedure | |
| 16: | procedure BFS(T_{avg}) | |
| 17: | childPathList ← GETCHILDPATHLAST(T_{avg}) | |
| 18: | for all child ∈ childPathList do | |
| 19: | UPDATEPATHCOLOR(child, ”BLACK”) | [symbol] Set all paths in avg to black |
| 20: | Masks ← ∅ | |
| 21: | queue ← ∅ | |
| 22: | queue.enqueue(T_{avg}) | |
| 23: | while not queue.isEmpty( ) do | |
| 24: | node ← queue.dequeue( ) | |
| 25: | if node is a group then | |
| 26: | childPathList ← GETCHILDPATHLIST(node) | |
| 27: | for all child ∈ childPathList do | |
| 28: | UPDATEPATHCOLOR(child, ”WHITE”) | [symbol] Set all paths in group to white to generate |

| | |
|---|---|
| | mask |
| 29: | end for |
| 30: | mask ← GETBFSMASK(node, node) |
| 31: | Masks ← Masks ∪ mask |
| 32: | for all child ∈ childPathList do |
| 33: | UPDATEPATHCOLOR(child, ”BLACK”) |
| 34: | end for |
| 35: | for all child ∈ node do |
| 36: | queue.enqueue(child) |
| 37: | end for |
| 38: | end if |
| 39: | end while |
| 40: | end for |
| 41: | end procedure |

As noted previously, user-tagged groups in vector images sometimes do not correspond to a single semantic object, but are instead grouped for other purposes (e.g., ease of editing, similar visual properties, similar locations). Accordingly, the vector object grouping system 102 utilizes the semantic information extracted from a vector image utilizing one or more segmentation neural networks in combination with the information about the user-tagged groups to identify likely semantic object groups. FIG. 5 illustrates an example process in which the vector object grouping system 102 selects one or more group masks corresponding to semantically relevant sets of objects using semantic information and explicit tagging of groups for a vector image.

As illustrated in FIG. 5, the vector object grouping system 102 determines segmentation masks 502 for a vector image utilizing one or more segmentation neural networks (e.g., as described with respect to FIG. 3). Additionally, the vector object grouping system 102 determines group masks 504 for user-tagged groups of objects in the vector image. The vector object grouping system 102 uses information from segmentation masks 502 and the group masks 504 to determine semantically relevant sets of objects in the vector image.

For example, as illustrated in FIG. 5, the vector object grouping system 102 utilizes a matching algorithm 506 to compare the segmentation masks 502 to the group masks 504. In one or more embodiments, the vector object grouping system 102 utilizes the matching algorithm 506 to determine how the group masks 504 overlap with the segmentation masks 502. For instance, the vector object grouping system 102 utilizes a bipartite matching algorithm to determine intersection-over-union metrics 508 for each of the group masks 504 in relation to each of the segmentation masks 502.

To illustrate, the vector object grouping system 102 utilizes a Hungarian bipartite matching algorithm to determine visual similarities between the segmentation masks 502 and the group masks 504 based on similarities of regions in the segmentation masks 502 and the group masks 504 (e.g., indicating how semantically related content in a group mask is). In one or more embodiments, the vector object grouping system 102 compares pixel values of the segmentation masks 502 and the group masks 504 to determine similarities between the segmentation masks 502 and the group masks 504. For example, the vector object grouping system 102 compares a group mask to each of the segmentation masks 502 to generate a plurality of intersection-over-union metrics for the group mask. The vector object grouping system 102 similarly compares each other group mask to the segmentation masks 502 to generate a plurality of intersection-over-union metrics for each of the group masks. In alternative embodiments, the vector object grouping system 102 utilizes a different matching algorithm (e.g., a greedy algorithm, a Hopcroft-Karp algorithm) or an image processing neural network to match the segmentation masks 502 with the group masks 504.

In one or more embodiments, the vector object grouping system 102 utilizes a plurality of operations in Algorithm 2 below to perform a bipartite matching algorithm to compare segmentation masks and group masks (e.g., BFS masks). Specifically, the vector object grouping system 102 utilizes a plurality of segmentation neural networks to generate a plurality of separate sets of segmentation masks.

Algorithm 2 Bipartite Matching

```
Require: EntitySegMask ESₘₐₛₖ, SAMMask SAMₘₐₛₖ,
SemanticSAMMask SSAMₘₐₛₖ, BFSMask BFSₘₐₛₖ
Ensure: Subject_{Masks} = { }
    procedure GETSUBJECTMASKS
  2: Segₘₐₛₖₛ ← ESₘₐₛₖ ∪ SAMₘₐₛₖ ∪ SSAMₘₐₛₖ
      n ← |BFSₘₐₛₖₛ|
  4: m ← |Segₘₐₛₖₛ|
      Initialize C as empty arrays of size nXm
  6: for i ← 1 to n do
        for j ← 1 to m do
  8:  $C [ i ] [ j ] ← \frac{Area ( {BFS}_{masks} [ i ] ⋂ {Seg}_{masks} [ j ] )}{Area ( {BFS}_{masks} [ i ] ⋃ {Seg}_{masks} [ j ] )}$
        end for
  10: end for
        BFS_{indices}; Seg_{indices} = HungarianLinearSumAssignment(C) [symbol]   Standard implementation of
    Hungarian linear sum assignment
  12: for i ← 1 to n do
          bfs_{index} ← BFS_{indices}[i]
  14: seg_{index} ← Seg_{indices}[i]
          if C[bfs_{index}][seg_{index}] ≥ 0.9 then
  16: Subjectmasks ← Subjectₘₐₛₖₛ ∪ bfsₘₐₛₖ
          end if
  18: end for
    end procedure
```

In one or more embodiments, the vector object grouping system 102 determines that a particular group mask corresponds to a set of objects that are semantically relevant by comparing the intersection-over-union metrics 508 to a threshold value 510. For example, the vector object grouping system 102 utilizes the threshold value 510 to determine whether it is likely that a particular group mask overlaps with a particular semantic mask. Thus, in response to determining that a particular intersection-over-union metric meets or exceeds the threshold value 510, the vector object grouping system 102 determines that the group mask corresponds to (or likely corresponds to) a semantically relevant set of objects. In response to determining that a particular intersection-over-union metric does not meet (e.g., is below) the threshold value 510, the vector object grouping system 102 determines that the group mask does not correspond to (or likely does not correspond to) a semantically relevant set of objects. As an example, the threshold value is 0.9, though in other examples, the threshold value is higher (e.g., 0.91) or lower (e.g., 0.87).

Furthermore, in one or more embodiments, the vector object grouping system 102 determines selected group mask(s) 512 in response to comparing the intersection-over-union metrics 508 to the threshold value 510. In particular, as indicated above, in response to determining that an intersection-over-union metric for a particular group mask meets the threshold value 510, the vector object grouping system 102 selects the group mask. Thus, the vector object grouping system 102 selects all group masks that have intersection-over-union metrics that meet the threshold value 510 as having semantically relevant sets of objects. By selecting group masks that meet the threshold while discarding other group masks that do not meet the threshold, the vector object grouping system 102 selects group masks that are most likely to have semantically related objects within each group. As an example, the vector object grouping system 102 selects a group mask for objects corresponding to different parts of a body based on semantic information from the segmentation masks 502 that indicates the objects are semantically related.

In one or more additional embodiments, the vector object grouping system 102 includes or excludes one or more group masks based on one or more other thresholds. For instance, the vector object grouping system 102 utilizes a size threshold to exclude group masks that do not meet a size or proportion threshold. To illustrate, the vector object grouping system 102 excludes group masks or segmentation masks from comparison in response to determining that the masks do not meet a size (e.g., number of pixels) threshold to prevent comparisons of small numbers of pixels.

In one or more embodiments, in response to determining group masks that correspond to semantically relevant sets of objects, the vector object grouping system 102 performs one or more downstream operations. For example, FIG. 6 illustrates that the vector object grouping system 102 generates data based on a group mask for a semantically relevant set of objects for use in one or more additional tasks. To illustrate, the vector object grouping system 102 generates training data from a group mask for use in training an image processing neural network to function more accurately on vector images.

As illustrated in FIG. 6, the vector object grouping system 102 determines a group mask 602 corresponding to a semantically relevant set of objects. In particular, the vector object grouping system 102 determines that the group mask 602 contains a semantically relevant set of objects based on semantic information from a segmentation mask. As an example, the vector object grouping system 102 determines that a set of objects in a vector image correspond to a recycle bin that is at least partially visible in the vector image based on a corresponding segmentation mask for the recycle bin.

In response to selecting the group mask 602, in one or more embodiments, the vector object grouping system 102 generates data for various downstream operations, such as for training an image processing neural network. Specifically, as illustrated in FIG. 6, the vector object grouping system 102 generates one or more masks and/or a color image based on the group mask 602. For example, the vector object grouping system 102 generates the mask(s)/image to use in training an image processing neural network to more accurately extract semantic object information from vector images or vector-like images.

For instance, FIG. 6 illustrates that the vector object grouping system 102 generates a partial mask 604 based on the group mask 602. In one or more embodiments, the partial mask 604 is the same as, or similar to, the group mask 602 according to one or more visible portions of the set of objects in a vector image. To illustrate, referring to the pervious example of a recycle bin, the vector object grouping system 102 generates the partial mask 604 to indicate the visible portions of the set of objects that make up the recycle bin included in the group mask 602.

In one or more embodiments, the vector object grouping system 102 utilizes an inpainting model 605 to generate a full mask 606 corresponding to the semantically relevant set of objects indicated by the group mask 602. In particular, if at least a portion of the set of objects is obscured by one or more other semantically unrelated objects in the vector image, the vector object grouping system 102 generates the full mask 606 to include the visible portion in the partial mask 604 in addition to one or more non-visible portions. Thus, the vector object grouping system 102 utilizes the inpainting model 605 to complete the portion of the semantic object that is not visible in the vector image.

According to one or more embodiments, an inpainting model includes an image generation neural network that fills portions of objects based on object classifications and/or contextual information from a digital image. For example, the inpainting model 605 utilizes semantic information about a set of objects (e.g., based on a segmentation mask for the set of objects) to generate visual data to fill in the hidden portions of an object. To illustrate, for a portion of a recycling bin hidden behind one or more trash bags, the vector object grouping system 102 utilizes the inpainting model 605 to fill in the hidden portion based on contextual information from the vector image (e.g., based on the object type of the semantic object and visual attributes of the semantic object). In some embodiments, the vector object grouping system 102 generates the full mask 606 by modifying values of the partial mask 604 (or group mask 602) utilizing the inpainting model 605. In some embodiments, for a semantic object that is fully visible in a vector image, the partial mask 604 and the full mask 606 are the same.

In connection with filling in the portion(s) of the set of objects, in some embodiments, the vector object grouping system 102 generates a color image 608 corresponding to the set of objects. In particular, the vector object grouping system 102 completes the semantic object utilizing the inpainting model 605 in an RGB image (or image of another color space). In one or more embodiments, in response to generating the color image 608, the vector object grouping system 102 generates the full mask 606 based on the completed semantic object in the color image 608. Alternatively, the vector object grouping system 102 generates the color image 608 utilizing the full mask 606 (e.g., by providing the full mask 606 and the vector image to the inpainting model 605 to generate the color image 608).

According to one or more embodiments, the vector object grouping system 102 utilizes generated data for group masks corresponding to semantically relevant sets of objects to train one or more neural networks. For example, the vector object grouping system 102 utilizes training data including generated masks and/or color images (e.g., as in FIG. 6) to train an image processing neural network for vector images and digital images that have similar visual properties to many vector images. FIG. 7 illustrates a process in which the vector object grouping system 102 generates a training dataset and using the training dataset to train an image processing neural network.

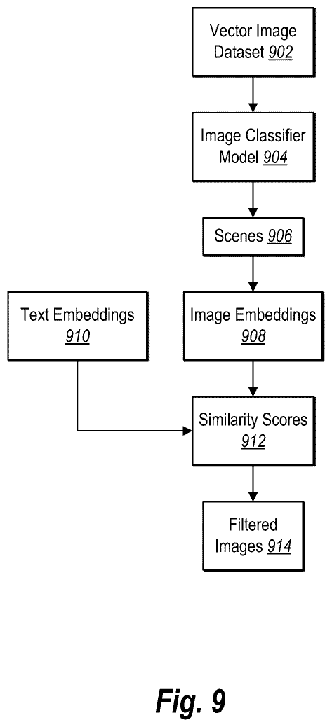

In particular, as illustrated in FIG. 7, the vector object grouping system 102 utilizes determines vector images 702 including vector objects of various types and arrangements. In some embodiments, as described in more detail with respect to FIG. 9, the vector object grouping system 102 filters a dataset of vector images to select vector images with specific visual properties. For example, the vector object grouping system 102 selects vector images with objects arranged in scenes, e.g., with a plurality of separate foreground elements against a background.

Additionally, in one or more embodiments, the vector object grouping system 102 utilizes an image processing neural network 704 to generate a predicted dataset 706. For instance, the image processing neural network 704 includes a generative neural network that generates vector images. In some embodiments, the vector object grouping system 102 utilizes the image processing neural network 704 to generate a set of masks (e.g., partial masks) and color images for semantic objects in the vector images 702. To illustrate, the vector object grouping system 102 generates a prompt to the image processing neural network 704 to generate the masks and color images in the predicted dataset 706 for semantically relevant objects in the vector images 702.

In one or more additional embodiments, the vector object grouping system 102 generates a ground-truth dataset 708 for the vector images 702. In particular, the vector object grouping system 102 utilizes the processes above (e.g., described in relation to FIGS. 2-6) to generate partial masks, full masks, and color images for semantically relevant sets of objects in the vector images 702. For example, the vector object grouping system 102 utilizes a plurality of segmentation neural networks to generate segmentation masks for the vector images 702. The vector object grouping system 102 also searches vector hierarchies of the vector images 702 to determine tagged groups of objects. The vector object grouping system 102 also selects groups of semantically relevant sets of objects by comparing the segmentation masks to the tagged groups of objects.

Furthermore, the vector object grouping system 102 compares the predicted dataset 706 to the ground-truth dataset 708 to determine a loss 710. For example, the vector object grouping system 102 determines the loss 710 by determining differences between the predicted dataset 706 and the ground-truth dataset 708. To illustrate, the vector object grouping system 102 determines differences between predicted partial masks and ground-truth partial masks, differences between predicted full masks and ground-truth full masks, and differences between predicted color images and ground-truth color images. Accordingly, the vector object grouping system 102 determines the loss 710 based on a combination of the various differences (e.g., a combination of a plurality of losses).

In one or more embodiments, the vector object grouping system 102 utilizes the loss 710 to train the image processing neural network 704. Specifically, the vector object grouping system 102 utilizes the loss 710 to adjust/optimize parameters of the image processing neural network 704 to reduce the differences between the predicted dataset 706 and the ground-truth dataset 708. For example, the vector object grouping system 102 utilizes the loss 710 to reduce differences between predicted masks and/or color images and ground-truth masks and/or color images. In some embodiments, the vector object grouping system 102 utilizes the loss 710 to train individual components of the image processing neural network 704 (e.g., an encoder or a decoder) or to jointly train components of the image processing neural network 704.

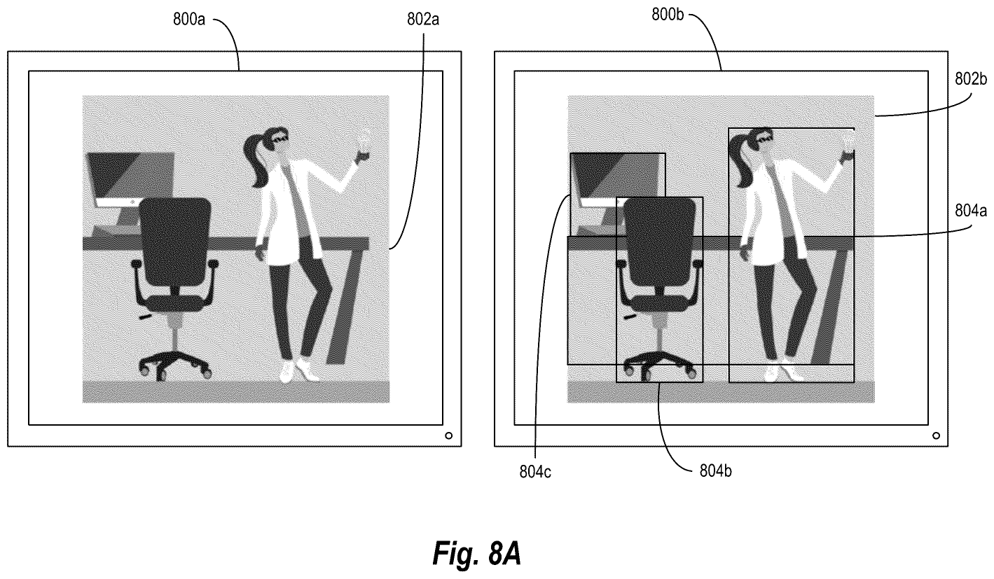

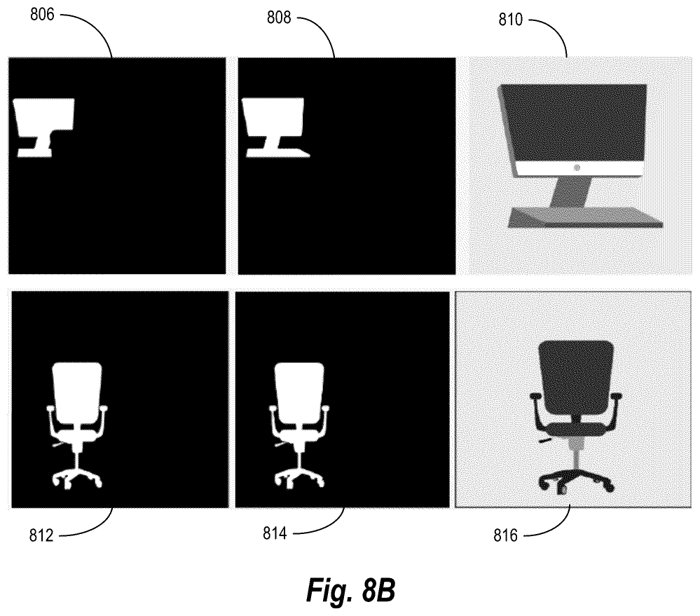

In one or more embodiments, the vector object grouping system 102 utilizes the processes for detecting semantically relevant sets of objects to provide visual cues in a graphical user interface. For example, FIG. 8A illustrates an example graphical user interface for displaying a vector image and visual cues highlighting semantically relevant groups of objects. FIG. 8B illustrates example masks and color images for various semantically relevant groups of objects detected in the vector image of FIG. 8A.

In particular, FIG. 8A illustrates a graphical user interface 800a displayed on a client device. Specifically, the graphical user interface 800a corresponds to a digital image application for viewing, generating, or editing vector images. As illustrated, the client device displays a vector image 802a in the graphical user interface 800a. In connection with a request to perform one or more operations on the vector image 802a (e.g., to detect semantically relevant sets of objects in the vector image 802a), the vector object grouping system 102 performs the previously described operations on the vector image 802a to detect semantically relevant sets of objects.

In one or more embodiments, in connection with detecting the semantically relevant sets of objects, the vector object grouping system 102 generates highlights for the semantically relevant sets of objects. For example, as illustrated, the vector object grouping system 102 generates bounding boxes to display around the semantically relevant sets of objects in a modified vector image 802b in graphical user interface 800b. To illustrate, the vector object grouping system 102 generates a first bounding box 804a around a first semantically relevant set of objects, a second bounding box 804b around a second semantically relevant set of objects, and a third bounding box 804c around a third semantically relevant set of objects. In various embodiments, the client device displays the bounding boxes as a cursor hovers over each semantic object, in response to the vector object grouping system 102 selecting the semantically relevant sets of objects, in response to a selection of an option to display the bounding boxes, or in connection with performing one or more additional image processing operations on the vector image 802a.

FIG. 8B illustrates a plurality of images that the vector object grouping system 102 generates for the vector image 802a of FIG. 8A. In particular, FIG. 8B illustrates masks and color images that the vector object grouping system 102 generates for different semantically relevant sets of objects in the vector image 802a. For example, the vector object grouping system 102 generates a partial mask 806, a full mask 808, and a color image 810 for the third semantically relevant set of objects (e.g., a desktop computer). Furthermore, the vector object grouping system 102 generates a partial mask 812, a full mask 814, and a color image 816 for the second semantically relevant set of objects (e.g., a desk chair). As illustrated, the vector object grouping system 102 utilizes an inpainting model to generate one or more of the full masks (e.g., the full mask 808) and the color images (e.g., the color image 810).

As mentioned, in some embodiments, the vector object grouping system 102 filters a dataset of vector images in connection with selecting vector images for generating a training dataset. FIG. 9 illustrates an example process in which the vector object grouping system 102 filters a dataset of vector images for images that contain scenes. In particular, the vector object grouping system 102 accesses a vector image dataset 902 including vector images. In some embodiments, the vector image dataset 902 also includes text captions for the vector images (e.g., text descriptions of various elements in each vector image).

Additionally, in one or more embodiments, the vector object grouping system 102 utilizes an image classifier model 904 to classify the vector images in the vector image dataset 902 based on the type of presentations in the vector images. More specifically, the vector object grouping system 102 utilizes the image classifier model 904 to classify the vector images as containing scenes 906 or not containing scenes. In one or more embodiments, the image classifier model 904 includes a vision transformer neural network to classify the vector images as containing scenes or not based on whether the vector images have a plurality of objects arranged against a background.

In response to determining vector images that contain scenes 906, the vector object grouping system 102 determines image embeddings 908 for the scenes 906 and text embeddings 910 for text captions of the scenes. In one or more embodiments, the vector object grouping system 102 utilizes a vision-language model that generates encodings of images and text in a shared feature space to generate the image embeddings 908 and the text embeddings 910. Specifically, the vector object grouping system 102 utilizes the vision-language model to generate an image embedding for a vector image and a text embedding for a text caption (or combination of text captions) of the vector image.

Furthermore, the vector object grouping system 102 generates similarity scores 912 by comparing the image embeddings 908 and the text embeddings 910. To illustrate, the vector object grouping system 102 determines a distance between each corresponding text embedding and image embedding in the feature space. In one or more embodiments, the vector object grouping system 102 compares the similarity scores 912 to a threshold score (e.g., 0.90) to determine whether the image embeddings 908 and the text embeddings 910 are close. In response to determining that a similarity score of a particular image embedding and text embedding meets the threshold score, the vector object grouping system 102 selects the corresponding vector image for the training dataset (e.g., in a set of filtered images 914).

In some embodiments, the vector object grouping system 102 also performs one or more additional filtering operations on the vector image dataset 902 to select vector images for the set of filtered images 914. Specifically, in some embodiments, the vector object grouping system 102 filters out vector images with patterns (e.g., via a pattern classifier). In some embodiments, the vector object grouping system 102 filters out grayscale images and/or line art images, such as by using a vision-language model to generate similarity scores to grayscale/line art content.

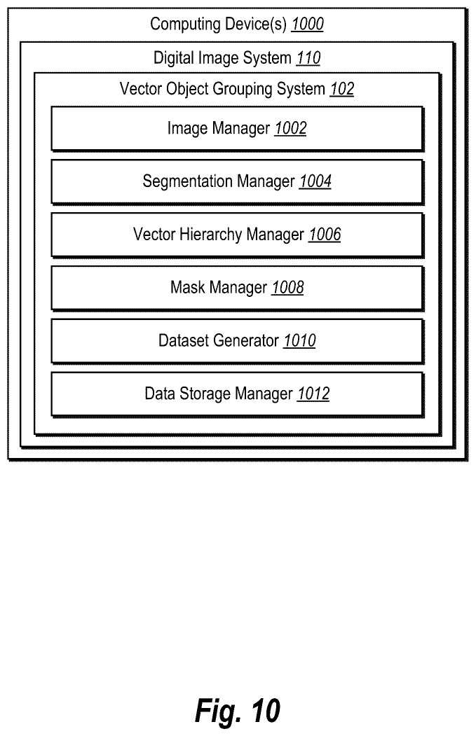

FIG. 10 illustrates a detailed schematic diagram of an embodiment of the vector object grouping system 102 described above. As shown, the vector object grouping system 102 is implemented in a digital image system 110 on computing device(s) 1000 (e.g., a client device and/or server device as described in FIG. 1, and as further described below in relation to FIG. 12). Additionally, the vector object grouping system 102 includes, but is not limited to, an image manager 1002, a segmentation manager 1004, a vector hierarchy manager 1006, a mask manager 1008, a dataset generator 1010, and a data storage manager 1012. In one or more embodiments, the vector object grouping system 102 is implemented on any number of computing devices. For example, the vector object grouping system 102, in one or more embodiments, is implemented in a distributed system of server devices for digital image processing. Alternatively, the vector object grouping system 102 is also implemented within one or more additional systems. For example, the vector object grouping system 102, in one or more embodiments, is implemented on a single computing device such as a single client device.

In one or more embodiments, each of the components of the vector object grouping system 102 is in communication with other components using any suitable communication technologies. Additionally, the components of the vector object grouping system 102 are capable of being in communication with one or more other devices including other computing devices of a user, server devices (e.g., cloud storage devices), licensing servers, or other devices/systems. It will be recognized that although the components of the vector object grouping system 102 are shown to be separate in FIG. 10, any of the subcomponents may be combined into fewer components, such as into a single component, or divided into more components as may serve a particular implementation. Furthermore, although the components of FIG. 10 are described in connection with the vector object grouping system 102, at least some of the components for performing operations in conjunction with the vector object grouping system 102 described herein are implemented on other devices within the environment in other embodiments.

In some embodiments, the components of the vector object grouping system 102 include software, hardware, or both. For example, the components of the vector object grouping system 102 include one or more instructions stored on a computer-readable storage medium and executable by processors of one or more computing devices (e.g., the computing device(s) 1000). When executed by the one or more processors, the computer-executable instructions of the vector object grouping system 102 cause the computing device(s) 1000 to perform the operations described herein. Alternatively, the components of the vector object grouping system 102 include hardware, such as a special purpose processing device to perform a certain function or group of functions. Additionally, or alternatively, the components of the vector object grouping system 102 include a combination of computer-executable instructions and hardware.

Furthermore, the components of the vector object grouping system 102 performing the functions described herein with respect to the vector object grouping system 102 may, for example, be implemented as part of a stand-alone application, as a module of an application, as a plug-in for applications, as a library function or functions that may be called by other applications, and/or as a cloud-computing model. Thus, the components of the vector object grouping system 102 may be implemented as part of a stand-alone application on a personal computing device or a mobile device. Alternatively, or additionally, the components of the vector object grouping system 102 may be implemented in any application that provides digital image editing, including, but not limited to ADOBE® ILLUSTRATOR® and ADOBE® CREATIVE CLOUD® software.

As illustrated, the vector object grouping system 102 includes an image manager 1002 to manage vector images for various image processing operations. In particular, the image manager 1002 accesses vector images for editing or other processing. Additionally, the image manager 1002 filters vector images in datasets of images for generating training datasets for training one or more neural networks (e.g., image processing neural networks).

The vector object grouping system 102 also includes a segmentation manager 1004 for segmenting vector images. Specifically, the segmentation manager 1004 utilizes one or more segmentation neural networks to generate segmentations for vector objects in vector images. Additionally, the segmentation manager 1004 generates segmentation masks for use in detecting semantically relevant sets of objects in vector images.

The vector object grouping system 102 includes a vector hierarchy manager 1006 for accessing and analyzing vector hierarchies of vector files of vector images. In particular, the vector hierarchy manager 1006 extracts a vector hierarchy (e.g., a tree structure of nodes) from a vector image and performs a search on the vector hierarchy. The vector hierarchy manager 1006 determines labels for nodes in the vector hierarchy indicating whether the nodes belong to a group of objects. In some embodiments, the vector hierarchy manager 1006 generates group masks for groups of objects based on the labels.

In one or more embodiments, the vector object grouping system 102 includes a mask manager 1008 to manage masks for objects in vector images. For example, the mask manager 1008 compares group masks to segmentation masks to select group masks that correspond to semantically relevant sets of objects. To illustrate, the mask manager 1008 utilizes performs a matching algorithm (e.g., bipartite matching) over segmentation masks and group masks to select group masks based on the semantic information in the segmentation masks.

The vector object grouping system 102 also includes a dataset generator 1010 to generate data based on group masks of semantically relevant sets of objects in vector images. For instance, the dataset generator 1010 generates masks (e.g., partial or full masks) and/or color images (e.g., RGB images) from group masks of semantically relevant sets of objects. In some embodiments, the dataset generator utilizes the generated datasets to train image processing neural networks.

The vector object grouping system 102 also includes a data storage manager 1012 (that comprises a non-transitory computer memory) that stores and maintains data associated with processing vector images to detect semantically relevant sets of objects. For example, the data storage manager 1012 stores vector objects and vector hierarchies in vector files of vector images, segmentation masks, and group masks. Additionally, the data storage manager 1012 stores data associated with generating training data, such as partial masks, full masks, or color images representing sets of objects in vector images.

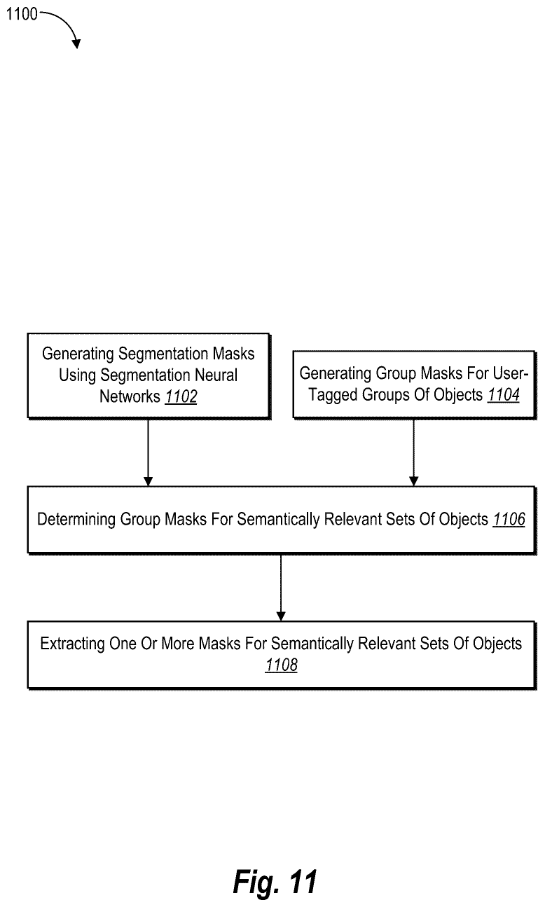

Turning now to FIG. 11, this figure shows a flowchart of a series of acts 1100 of determining semantically relevant sets of objects in a vector image based on semantic segmentations and user-tagged groups. While FIG. 11 illustrates acts according to one embodiment, alternative embodiments may omit, add to, reorder, and/or modify any of the acts shown in FIG. 11. The acts of FIG. 11 are part of a method. Alternatively, a non-transitory computer readable medium comprises instructions, that when executed by one or more processors, cause the one or more processors to perform the acts of FIG. 11. In still further embodiments, a system includes a processor or server configured to perform the acts of FIG. 11.

As shown, the series of acts 1100 includes an act 1102 of generating segmentation masks using segmentation neural networks. The series of acts 1100 also includes an act 1104 of generating group masks for user-tagged groups of objects. The series of acts 1100 further includes an act 1106 of determining group masks for semantically relevant sets of objects. Additionally, the series of acts 1100 includes an act 1108 of extracting one or more masks for semantically relevant sets of objects.

In one or more embodiments, act 1102 involves generating, utilizing one or more segmentation neural networks, one or more segmentation masks comprising a plurality of semantic segmentations. Additionally, act 1104 involves generating one or more group masks corresponding to user-tagged groups of objects in a vector image by executing search algorithm on a vector hierarchy of the vector image. Act 1106 involves determining, from the one or more group masks, a group mask comprising a semantically relevant set of objects based on semantic information from the one or more segmentation masks. Act 1108 involves extracting, from the group mask, a partial mask or a full mask corresponding to the semantically relevant set of objects.

In one or more embodiments, the series of acts 1100 includes executing the search algorithm on the vector hierarchy to determine a first user-tagged group of objects from a first node in a tree structure and a second user-tagged group of objects from a second node in the tree structure. The series of acts 1100 further includes generating a first group mask for the first user-tagged group of objects and a second group mask for the second user-tagged group of objects.

In one or more embodiments, the series of acts 1100 includes comparing the first group mask to the one or more segmentation masks by generating an intersection-over-union metric utilizing bipartite matching. The series of acts 1100 also includes determining that a set of objects in the first user-tagged group of objects are semantically relevant in response to determining that the intersection-over-union metric meets a threshold value.

According to one or more embodiments, the series of acts 1100 includes comparing the second group mask to the one or more segmentation masks by generating an intersection-over-union metric utilizing bipartite matching. The series of acts 1100 further includes determining that a set of objects in the second user-tagged group of objects are not semantically relevant in response to determining that the intersection-over-union metric does not meet a threshold value.

In one or more embodiments, the series of acts 1100 includes generating, by at least one processor, one or more group masks corresponding to user-tagged groups of objects in a vector image by executing a search on a vector hierarchy of the vector image. The series of acts 1100 further includes determining, by the at least one processor and from the one or more group masks, a group mask comprising a semantically relevant set of objects based on semantic information from one or more segmentation masks comprising a plurality of semantic segmentations generated utilizing one or more segmentation neural networks. The series of acts 1100 also includes extracting, by the at least one processor and from the group mask, one or more masks corresponding to the semantically relevant set of objects.

In some embodiments, the series of acts 1100 includes generating the one or more segmentation masks by generating the plurality of semantic segmentations utilizing a plurality of separate segmentation neural networks. In some embodiments, the series of acts 1100 includes extracting the vector hierarchy from a vector file of the vector image, the vector hierarchy comprising a plurality of nodes corresponding to vector objects in a tree structure. Furthermore, the series of acts 1100 also includes executing the search on the vector hierarchy utilizing a breadth first search algorithm to determine the user-tagged groups of objects based on tags of the plurality of nodes in the tree structure.

In one or more embodiments, the series of acts 1100 includes determining a first user-tagged group of objects and a second user-tagged group of objects in response to executing the breadth first search algorithm. Additionally, the series of acts 1100 includes generating a first group mask for the first user-tagged group of objects and a second group mask for the second user-tagged group of objects.

In one or more embodiments, the series of acts 1100 also includes determining an intersection-over-union metric for the group mask in relation to the one or more segmentation masks. The series of acts 1100 also includes selecting the group mask in response to determining that the intersection-over-union metric meets a threshold value. Furthermore, in some embodiments, the series of acts 1100 includes filtering the group mask from the one or more masks by utilizing bipartite matching on the one or more group masks and the one or more segmentation masks to determine the intersection-over-union metric.

In one or more embodiments, the series of acts 1100 includes extracting, utilizing the group mask and the vector image, a partial mask, a full mask, or a color image corresponding to the semantically relevant set of objects. Furthermore, in some embodiments, the series of acts 1100 includes determining a set of predicted masks and color images generated for the vector image utilizing an image processing neural network. The series of acts 1100 also includes optimizing parameters of the image processing neural network to reduce differences between the set of predicted masks and color images and a set of ground truth masks and color images comprising the partial mask, the full mask, and the color image corresponding to the semantically relevant set of objects.

In one or more embodiments, the series of acts 1100 includes filtering, from a vector image dataset, a plurality of vector images comprising the vector image by utilizing an image classifier model to determine that the vector image comprises a scene layout. The series of acts 1100 also includes determining distances between text embeddings representing elements in the plurality of vector images to image embeddings of the plurality of vector images. Additionally, the series of acts 1100 includes selecting the vector image from a subset of vector images having a similarity score above a threshold score based on the distances between the text embeddings and the image embeddings.

In one or more embodiments, the series of acts 1100 includes generating one or more group masks corresponding to user-tagged groups of objects in a vector image by executing a search on a vector hierarchy of the vector image. The series of acts 1100 further includes determining, utilizing bipartite matching, intersection-over-union metrics for the one or more group masks and one or more segmentation masks comprising a plurality of semantic segmentations generated utilizing one or more segmentation neural networks. The series of acts 1100 also includes determining, from the one or more group masks, a group mask comprising a semantically relevant set of objects according to the intersection-over-union metrics. Additionally, the series of acts 1100 includes extracting, from the group mask, one or more masks corresponding to the semantically relevant set of objects.

In one or more embodiments, the series of acts 1100 includes generating the one or more segmentation masks by generating a first set of semantic segmentations utilizing a first segmentation neural networks, and generating a second set of semantic segmentations utilizing a second segmentation neural network. Additionally, the series of acts 1100 includes determining the intersection-over-union metrics for the one or more group masks by comparing the one or more group masks to a combined set of semantic segmentations comprising the first set of semantic segmentations and the second set of semantic segmentations.

In one or more embodiments, the series of acts 1100 includes determining a first intersection-over-union metric for a first group mask relative to the plurality of semantic segmentations. The series of acts 1100 further includes determining a second intersection-over-union metric for a second group mask relative to the plurality of semantic segmentations. In one or more embodiments, the series of acts 1100 includes determining that the first group mask comprises semantically relevant objects in response to determining that the first intersection-over-union metric meets a threshold value. In some embodiments, the series of acts 1100 includes determining that the second group mask does not comprise semantically relevant objects in response to determining that the second intersection-over-union metric does not meet a threshold value.

In some embodiments, the series of acts 1100 includes extracting, from a vector file of the vector image, the vector hierarchy comprising a plurality of nodes corresponding to vector objects. Additionally, the series of acts 1100 includes executing a breadth first search algorithm on the vector hierarchy to determine the user-tagged groups of objects.

In one or more embodiments, the series of acts 1100 includes extracting a partial mask, a full mask, and a color image of the semantically relevant set of objects based on the group mask and the vector image.

Embodiments of the present disclosure may comprise or utilize a special purpose or general-purpose computer including computer hardware, such as, for example, one or more processors and system memory, as discussed in greater detail below. Embodiments within the scope of the present disclosure also include physical and other computer-readable media for carrying or storing computer-executable instructions and/or data structures. In particular, one or more of the processes described herein may be implemented at least in part as instructions embodied in a non-transitory computer-readable medium and executable by one or more computing devices (e.g., any of the media content access devices described herein). In general, a processor (e.g., a microprocessor) receives instructions, from a non-transitory computer-readable medium, (e.g., a memory, etc.), and executes those instructions, thereby performing one or more processes, including one or more of the processes described herein.

Computer-readable media can be any available media that can be accessed by a general purpose or special purpose computer system. Computer-readable media that store computer-executable instructions are non-transitory computer-readable storage media (devices). Computer-readable media that carry computer-executable instructions are transmission media. Thus, by way of example, and not limitation, embodiments of the disclosure can comprise at least two distinctly different kinds of computer-readable media: non-transitory computer-readable storage media (devices) and transmission media.

Non-transitory computer-readable storage media (devices) includes RAM, ROM, EEPROM, CD-ROM, solid state drives (“SSDs”) (e.g., based on RAM), Flash memory, phase-change memory (“PCM”), other types of memory, other optical disk storage, magnetic disk storage or other magnetic storage devices, or any other medium which can be used to store desired program code means in the form of computer-executable instructions or data structures and which can be accessed by a general purpose or special purpose computer.

A “network” is defined as one or more data links that enable the transport of electronic data between computer systems and/or modules and/or other electronic devices. When information is transferred or provided over a network or another communications connection (either hardwired, wireless, or a combination of hardwired or wireless) to a computer, the computer properly views the connection as a transmission medium. Transmissions media can include a network and/or data links which can be used to carry desired program code means in the form of computer-executable instructions or data structures and which can be accessed by a general purpose or special purpose computer. Combinations of the above should also be included within the scope of computer-readable media.

Further, upon reaching various computer system components, program code means in the form of computer-executable instructions or data structures can be transferred automatically from transmission media to non-transitory computer-readable storage media (devices) (or vice versa). For example, computer-executable instructions or data structures received over a network or data link can be buffered in RAM within a network interface module (e.g., a “NIC”), and eventually transferred to computer system RAM and/or to less volatile computer storage media (devices) at a computer system. Thus, it should be understood that non-transitory computer-readable storage media (devices) can be included in computer system components that also (or even primarily) utilize transmission media.

Computer-executable instructions comprise, for example, instructions and data which, when executed at a processor, cause a general-purpose computer, special purpose computer, or special purpose processing device to perform a certain function or group of functions. In some embodiments, computer-executable instructions are executed on a general-purpose computer to turn the general-purpose computer into a special purpose computer implementing elements of the disclosure. The computer executable instructions may be, for example, binaries, intermediate format instructions such as assembly language, or even source code. Although the subject matter has been described in language specific to structural features and/or methodological acts, it is to be understood that the subject matter defined in the appended claims is not necessarily limited to the described features or acts described above. Rather, the described features and acts are disclosed as example forms of implementing the claims.

Those skilled in the art will appreciate that the disclosure may be practiced in network computing environments with many types of computer system configurations, including, personal computers, desktop computers, laptop computers, message processors, hand-held devices, multi-processor systems, microprocessor-based or programmable consumer electronics, network PCs, minicomputers, mainframe computers, mobile telephones, PDAs, tablets, pagers, routers, switches, and the like. The disclosure may also be practiced in distributed system environments where local and remote computer systems, which are linked (either by hardwired data links, wireless data links, or by a combination of hardwired and wireless data links) through a network, both perform tasks. In a distributed system environment, program modules may be located in both local and remote memory storage devices.

Embodiments of the present disclosure can also be implemented in cloud computing environments. In this description, “cloud computing” is defined as a model for enabling on-demand network access to a shared pool of configurable computing resources. For example, cloud computing can be employed in the marketplace to offer ubiquitous and convenient on-demand access to the shared pool of configurable computing resources. The shared pool of configurable computing resources can be rapidly provisioned via virtualization and released with low management effort or service provider interaction and scaled accordingly.

A cloud-computing model can be composed of various characteristics such as, for example, on-demand self-service, broad network access, resource pooling, rapid elasticity, measured service, and so forth. A cloud-computing model can also expose various service models, such as, for example, Software as a Service (“SaaS”), Platform as a Service (“PaaS”), and Infrastructure as a Service (“IaaS”). A cloud-computing model can also be deployed using different deployment models such as private cloud, community cloud, public cloud, hybrid cloud, and so forth. In this description and in the claims, a “cloud-computing environment” is an environment in which cloud computing is employed.

FIG. 12 illustrates a block diagram of exemplary computing device 1200 that may be configured to perform one or more of the processes described above. One will appreciate that one or more computing devices such as the computing device 1200 may implement the system(s) of FIG. 1. As shown by FIG. 12, the computing device 1200 can comprise a processor 1202, a memory 1204, a storage device 1206, an I/O interface 1208, and a communication interface 1210, which may be communicatively coupled by way of a communication infrastructure 1212. In certain embodiments, the computing device 1200 can include fewer or more components than those shown in FIG. 12. Components of the computing device 1200 shown in FIG. 12 will now be described in additional detail.

In one or more embodiments, the processor 1202 includes hardware for executing instructions, such as those making up a computer program. As an example, and not by way of limitation, to execute instructions for dynamically modifying workflows, the processor 1202 may retrieve (or fetch) the instructions from an internal register, an internal cache, the memory 1204, or the storage device 1206 and decode and execute them. The memory 1204 may be a volatile or non-volatile memory used for storing data, metadata, and programs for execution by the processor(s). The storage device 1206 includes storage, such as a hard disk, flash disk drive, or other digital storage device, for storing data or instructions for performing the methods described herein.

The I/O interface 1208 allows a user to provide input to, receive output from, and otherwise transfer data to and receive data from computing device 1200. The I/O interface 1208 may include a mouse, a keypad or a keyboard, a touch screen, a camera, an optical scanner, network interface, modem, other known I/O devices or a combination of such I/O interfaces. The I/O interface 1208 may include one or more devices for presenting output to a user, including, but not limited to, a graphics engine, a display (e.g., a display screen), one or more output drivers (e.g., display drivers), one or more audio speakers, and one or more audio drivers. In certain embodiments, the I/O interface 1208 is configured to provide graphical data to a display for presentation to a user. The graphical data may be representative of one or more graphical user interfaces and/or any other graphical content as may serve a particular implementation.

The communication interface 1210 can include hardware, software, or both. In any event, the communication interface 1210 can provide one or more interfaces for communication (such as, for example, packet-based communication) between the computing device 1200 and one or more other computing devices or networks. As an example, and not by way of limitation, the communication interface 1210 may include a network interface controller (NIC) or network adapter for communicating with an Ethernet or other wire-based network or a wireless NIC (WNIC) or wireless adapter for communicating with a wireless network, such as a WI-FI.

Additionally, the communication interface 1210 may facilitate communications with various types of wired or wireless networks. The communication interface 1210 may also facilitate communications using various communication protocols. The communication infrastructure 1212 may also include hardware, software, or both that couples components of the computing device 1200 to each other. For example, the communication interface 1210 may use one or more networks and/or protocols to enable a plurality of computing devices connected by a particular infrastructure to communicate with each other to perform one or more aspects of the processes described herein. To illustrate, the digital content campaign management process can allow a plurality of devices (e.g., a client device and server devices) to exchange information using various communication networks and protocols for sharing information such as electronic messages, user interaction information, engagement metrics, or campaign management resources.

In the foregoing specification, the present disclosure has been described with reference to specific exemplary embodiments thereof. Various embodiments and aspects of the present disclosure(s) are described with reference to details discussed herein, and the accompanying drawings illustrate the various embodiments. The description above and drawings are illustrative of the disclosure and are not to be construed as limiting the disclosure. Numerous specific details are described to provide a thorough understanding of various embodiments of the present disclosure.

The present disclosure may be embodied in other specific forms without departing from its spirit or essential characteristics. The described embodiments are to be considered in all respects only as illustrative and not restrictive. For example, the methods described herein may be performed with less or more steps/acts or the steps/acts may be performed in differing orders. Additionally, the steps/acts described herein may be repeated or performed in parallel with one another or in parallel with different instances of the same or similar steps/acts. The scope of the present application is, therefore, indicated by the appended claims rather than by the foregoing description. All changes that come within the meaning and range of equivalency of the claims are to be embraced within their scope.

What is claimed is:

1. A computer-implemented method comprising:
generating, by at least one processor, one or more group masks corresponding to user-tagged groups of objects in a vector image by executing a search on a vector hierarchy of the vector image;
determining, by the at least one processor and from the one or more group masks, a group mask comprising a semantically relevant set of objects based on semantic information from one or more segmentation masks comprising a plurality of semantic segmentations generated utilizing one or more segmentation neural networks; and
extracting, by the at least one processor and from the group mask, one or more masks corresponding to the semantically relevant set of objects.

2. The computer-implemented method of claim 1, further comprising generating the one or more segmentation masks by generating the plurality of semantic segmentations utilizing a plurality of separate segmentation neural networks.

3. The computer-implemented method of claim 1, wherein generating the one or more group masks comprises:
extracting the vector hierarchy from a vector file of the vector image, the vector hierarchy comprising a plurality of nodes corresponding to vector objects in a tree structure; and
executing the search on the vector hierarchy utilizing a breadth first search algorithm to determine the user-tagged groups of objects based on tags of the plurality of nodes in the tree structure.

4. The computer-implemented method of claim 3, wherein generating the one or more group masks comprises:
determining a first user-tagged group of objects and a second user-tagged group of objects in response to executing the breadth first search algorithm; and
generating a first group mask for the first user-tagged group of objects and a second group mask for the second user-tagged group of objects.

5. The computer-implemented method of claim 1, wherein determining the group mask comprises:
determining an intersection-over-union metric for the group mask in relation to the one or more segmentation masks; and
selecting the group mask in response to determining that the intersection-over-union metric meets a threshold value.

6. The computer-implemented method of claim 5, wherein determining the group mask comprises filtering the group mask from the one or more masks by utilizing bipartite matching on the one or more group masks and the one or more segmentation masks to determine the intersection-over-union metric.

7. The computer-implemented method of claim 1, wherein extracting the one or more masks comprises extracting, utilizing the group mask and the vector image, a partial mask, a full mask, or a color image corresponding to the semantically relevant set of objects.

8. The computer-implemented method of claim 7, further comprising:
determining a set of predicted masks and color images generated for the vector image utilizing an image processing neural network; and
optimizing parameters of the image processing neural network to reduce differences between the set of predicted masks and color images and a set of ground truth masks and color images comprising the partial mask, the full mask, and the color image corresponding to the semantically relevant set of objects.

9. The computer-implemented method of claim 1, further comprising:
filtering, from a vector image dataset, a plurality of vector images comprising the vector image by utilizing an image classifier model to determine that the vector image comprises a scene layout;
determining distances between text embeddings representing elements in the plurality of vector images to image embeddings of the plurality of vector images; and
selecting the vector image from a subset of vector images having a similarity score above a threshold score based on the distances between the text embeddings and the image embeddings.

10. A system comprising:
one or more memory devices; and
one or more processors configured to cause the system to:
generate one or more group masks corresponding to user-tagged groups of objects in a vector image by executing a search on a vector hierarchy of the vector image;
determine, utilizing bipartite matching, intersection-over-union metrics for the one or more group masks and one or more segmentation masks comprising a plurality of semantic segmentations generated utilizing one or more segmentation neural networks;
determine, from the one or more group masks, a group mask comprising a semantically relevant set of objects according to the intersection-over-union metrics; and
extract, from the group mask, one or more masks corresponding to the semantically relevant set of objects.

11. The system of claim 10, wherein the one or more processors are configured to cause the system to:
generate the one or more segmentation masks by:
generating a first set of semantic segmentations utilizing a first segmentation neural networks; and
generating a second set of semantic segmentations utilizing a second segmentation neural network; and
determine the intersection-over-union metrics for the one or more group masks by comparing the one or more group masks to a combined set of semantic segmentations comprising the first set of semantic segmentations and the second set of semantic segmentations.

12. The system of claim 10, wherein the one or more processors are configured to cause the system to determine the intersection-over-union metrics for the one or more group masks by:
determining a first intersection-over-union metric for a first group mask relative to the plurality of semantic segmentations; and
determining a second intersection-over-union metric for a second group mask relative to the plurality of semantic segmentations.

13. The system of claim 12, wherein the one or more processors are configured to cause the system to determine the group mask comprising the semantically relevant set of objects by determining that the first group mask comprises semantically relevant objects in response to determining that the first intersection-over-union metric meets a threshold value.

14. The system of claim 12, wherein the one or more processors are configured to cause the system to determine that the second group mask does not comprise semantically relevant objects in response to determining that the second intersection-over-union metric does not meet a threshold value.

15. The system of claim 10, wherein the one or more processors are configured to cause the system to generate the one or more group masks by:
extracting, from a vector file of the vector image, the vector hierarchy comprising a plurality of nodes corresponding to vector objects; and
executing a breadth first search algorithm on the vector hierarchy to determine the user-tagged groups of objects.

16. The system of claim 10, wherein the one or more processors are configured to cause the system to extract the one or more masks corresponding to the semantically relevant set of objects by extracting a partial mask, a full mask, and a color image of the semantically relevant set of objects based on the group mask and the vector image.

17. A non-transitory computer readable medium storing instructions thereon that, when executed by at least one processor, cause the at least one processor to perform operations comprising:
generating, utilizing one or more segmentation neural networks, one or more segmentation masks comprising a plurality of semantic segmentations;
generating one or more group masks corresponding to user-tagged groups of objects in a vector image by executing search algorithm on a vector hierarchy of the vector image;
determining, from the one or more group masks, a group mask comprising a semantically relevant set of objects based on semantic information from the one or more segmentation masks; and
extracting, from the group mask, a partial mask or a full mask corresponding to the semantically relevant set of objects.

18. The non-transitory computer readable medium of claim 17, wherein generating the one or more group masks comprises:
executing the search algorithm on the vector hierarchy to determine a first user-tagged group of objects from a first node in a tree structure and a second user-tagged group of objects from a second node in the tree structure; and
generating a first group mask for the first user-tagged group of objects and a second group mask for the second user-tagged group of objects.

19. The non-transitory computer readable medium of claim 18, wherein determining the group mask comprises:
comparing the first group mask to the one or more segmentation masks by generating an intersection-over-union metric utilizing bipartite matching; and
determining that a set of objects in the first user-tagged group of objects are semantically relevant in response to determining that the intersection-over-union metric meets a threshold value.

20. The non-transitory computer readable medium of claim 18, wherein the operations further comprise:
comparing the second group mask to the one or more segmentation masks by generating an intersection-over-union metric utilizing bipartite matching; and
determining that a set of objects in the second user-tagged group of objects are not semantically relevant in response to determining that the intersection-over-union metric does not meet a threshold value.
